(19) United States
(12) Patent Application Publication
(10) Pub. No.: US 2020/0184870 A1
(43) Pub. Date: Jun. 11, 2020

(54) SOURCE DRIVER

(71) Applicant: Novatek Microelectronics Corp., Hsinchu (TW)

(72) Inventors: Po-Hsiang Fang, Hsinchu City (TW); Jhih-Siou Cheng, New Taipei City (TW); Wen-Ching Huang, Hsinchu City (TW)

(73) Assignee: Novatek Microelectronics Corp., Hsinchu (TW)

(21) Appl. No.: 16/445,227

(22) Filed: Jun. 19, 2019

Related U.S. Application Data
(60) Provisional application No. 62/776,398, filed on Dec. 6, 2018.

(51) Int. Cl. G09G 3/20

(52) U.S. Cl. CPC G09G 3/20; G09G 2310/0294

(57) ABSTRACT

A source driver is provided. The source driver includes an integrated circuit chip, a sensitive circuit and at least one bump. The sensitive circuit is disposed in the integrated circuit chip. The sensitive circuit includes at least one capacitor. The at least one bump is disposed in the integrated circuit chip, and the at least one bump is adjacent to the sensitive circuit.

### CROSS-REFERENCE TO RELATED APPLICATION

This application claims the priority benefit of U.S. provisional application Ser. No. 62/776,398, filed on Dec. 6, 2018. The entirety of the above-mentioned patent application is hereby incorporated by reference herein and made a part of this specification.

### BACKGROUND

### Technical Field

The disclosure relates to a display driver, and particularly relates to a source driver for a display panel.

### Description of Related Art

In general, a package process of a display driver may include some heating processes, so that some specific materials for the package process can be formed in the display driver. For example, in a chip on film (COF) process, an integrated circuit of the display driver and a flexible printed circuit (FPC) film may be mounted together by heating a metal material or an organic material, where the metal material or the organic material may be formed between the display driver and the flexible printed circuit film. However, the display driver may include some sensitive circuits, such as a sample-and-hold circuit or an analog-to-digital conversion circuit having at least one capacitor. Therefore, the display driver is sensitive to structural deformation, for example, the capacitive characteristics of the at least one capacitor may be change with the structural deformation caused by the heating process. Accordingly, how to effectively prevent or reduce the influence of structural deformation of an integrated circuit chip caused by the heating process, the solutions of several embodiments are provided below.

### SUMMARY

The disclosure is directed to a source driver that is capable of effectively preventing or reducing the influence of structural deformation of an integrated circuit chip caused by a heating process.

The source driver of the disclosure includes an integrated circuit chip, a sample-and-hold circuit and an at least one bump. The sample-and-hold circuit is disposed in the integrated circuit chip. The sample-and-hold circuit includes at least one capacitor. The at least one bump is disposed in the integrated circuit chip. The at least one bump is adjacent to the sample-and-hold circuit.

In an embodiment of the disclosure, a first distance between the at least one bump and the sample-and-hold circuit is less than a second distance between the at least one bump and a boundary of the integrated circuit chip.

In an embodiment of the disclosure, the at least one bump and the sample-and-hold circuit are disposed in a specific region of the integrated circuit chip. The specific region is far from a boundary of the integrated circuit chip. The at least one bump is a non-input-output bump. A region outside the specific region includes at least another bump.

In an embodiment of the disclosure, the source driver further includes a film. The film is disposed below the integrated circuit chip. The film and the integrated circuit chip are mounted together by the at least one bump. A side of the integrated circuit chip having the sample-and-hold circuit is disposed to face the film, and a gap is existed between the integrated circuit chip and the film.

In an embodiment of the disclosure, the source driver further includes a plurality of bumps. The plurality of bumps are disposed in the integrated circuit chip and surround the sample-and-hold circuit.

In an embodiment of the disclosure, the plurality of bumps are adjacently located on at least two sides or at least two corners of the sample-and-hold circuit.

In an embodiment of the disclosure, the at least one bump forms a closed shape or an open shape to surround the sample-and-hold circuit.

The source driver of the disclosure includes an integrated circuit, an analog-to-digital conversion circuit and at least one bump. The analog-to-digital conversion circuit is disposed in the integrated circuit chip. The analog-to-digital conversion circuit includes at least one capacitor. The at least one bump is disposed in the integrated circuit chip. The at least one bump is adjacent to the analog-to-digital conversion circuit.

In an embodiment of the disclosure, a first distance between the at least one bump and the analog-to-digital conversion circuit is less than a second distance between the at least one bump and a boundary of the integrated circuit chip.

In an embodiment of the disclosure, the at least one bump and the analog-to-digital conversion circuit are disposed in a specific region of the integrated circuit chip. The specific region is far from a boundary of the integrated circuit chip. The at least one bump is a non-input-output bump. A region outside the specific region includes at least another bump.

In an embodiment of the disclosure, the source driver further includes a film. The film is disposed below the integrated circuit chip. The film and the integrated circuit chip are mounted together by the at least one bump. A side of the integrated circuit chip having the analog-to-digital conversion circuit is disposed to face the film, and a gap is existed between the integrated circuit chip and the film.

In an embodiment of the disclosure, the source driver further includes a plurality of bumps. The plurality of bumps are disposed in the integrated circuit chip and surround the analog-to-digital conversion circuit.

In an embodiment of the disclosure, the plurality of bumps are adjacently located on at least two sides or at least two corners of the analog-to-digital conversion circuit.

In an embodiment of the disclosure, the at least one bump forms a closed shape or an open shape to surround the analog-to-digital conversion circuit.

Based on the above, the source driver of the disclosure that can effectively prevent or reduce the influence of structural deformation of an integrated circuit chip caused by a heating process by additionally arranging at least one bump. The at least one bump is disposed between in the integrated circuit chip and the film, and the at least one bump is adjacent to the sensitive circuit, so as to effectively maintain the structure of the integrated circuit chip during the heating process.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a block diagram illustrating a source driver according to an embodiment of the disclosure.

FIG. 2 is a side view diagram illustrating a source driver according to an embodiment of the disclosure.

FIG. 3 is a circuit diagram illustrating a sample-and-hold unit according to an embodiment of the disclosure.

FIG. 4 is a top view diagram along the direction P3 illustrating an integrated circuit chip according to a first embodiment of the disclosure.

FIG. 5 is a top view diagram along the direction P3 illustrating an integrated circuit chip according to a second embodiment of the disclosure.

FIG. 6 is a top view diagram along the direction P3 illustrating an integrated circuit chip according to a third embodiment of the disclosure.

FIG. 7 is a top view diagram along the direction P3 illustrating an integrated circuit chip according to a fourth embodiment of the disclosure.

### DESCRIPTION OF THE EMBODIMENTS

It is to be understood that other embodiments may be utilized and structural changes may be made without departing from the scope of the disclosure. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

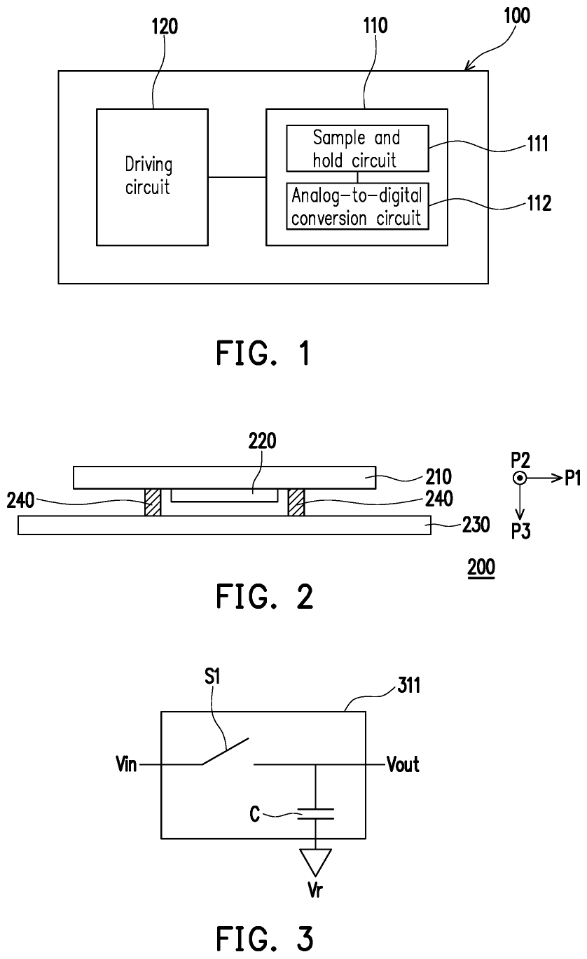

FIG. 1 is a block diagram illustrating a source driver according to an embodiment of the disclosure. Referring to FIG. 1, the source drive 100 includes a sensing circuit 110 and a driving circuit 120. The sensing circuit 110 is coupled to the driving circuit 120. The sensing circuit 110 includes a sample-and-hold circuit 111 and an analog-to-digital conversion circuit 112. The sample-and-hold circuit 111 is coupled to the analog-to-digital conversion circuit 112. The source driver 100 may be configured to drive an organic light-emitting diode (OLED) display panel or light-emitting diode (LED) display panel, etc., but the disclosure is not limited thereto. In the present embodiment, the sensing circuit 110 is configured to sense and sample a panel by the sample-and-hold circuit 111 and the analog-to-digital conversion circuit 112 to provide a panel state information of the panel to, for example, a timing controller (TCON), and the driving circuit 120 may correspondingly adjust the driving signal for the panel based on the panel state information of the panel.

For example, in some embodiments of the disclosure, the source drive 100 may be configured to drive an organic light emitting diode (OLED) display panel. In view of the aging problem of the organic light emitting diode display panel, the source drive 100 may sense a plurality of pixel units of the organic light emitting diode display panel by the sensing circuit 110 to monitor brightness decay of the pixel units during the driving of the panel, and the source drive 100 may correspondingly compensate the driving voltages of the pixel units by the driving circuit 120 to maintain the brightness of the pixel units. Therefore, the source drive 100 may include one or more sensitive circuit, such as the sample-and-hold circuit 111 and the analog-to-digital conversion circuit 112.

More specifically, in some embodiments of the disclosure, the source drive 100 may be fabricated by a chip on film (COF) packaging process, so the source drive 100 may be processed by a heating process during the chip on film packaging process. Furthermore, the sample-and-hold circuit 111 and the analog-to-digital conversion circuit 112 may be disposed in an active region of an integrated circuit (IC) chip, and the sample-and-hold circuit 111 and the analog-to-digital conversion circuit 112 may respectively include at least one capacitor. However, owing to the characteristics of the capacitor structure, the sample-and-hold circuit 111 and the analog-to-digital conversion circuit 112 are sensitive to structural deformation caused by the heating process. That is, if the integrated circuit chip is bent after the heating process, the electrical properties of the capacitor in the sample-and-hold circuit 111 or the analog-to-digital conversion circuit 112 may be changed accordingly, and a sample result of the sample-and-hold circuit 111 or a conversion result of the analog-to-digital conversion circuit 112 may also be erroneous correspondingly. Therefore, the source drive 100 of the disclosure further includes at least one bump disposed in the integrated circuit chip and adjacent to the sample-and-hold circuit 111 or the analog-to-digital conversion circuit 112 to provide a supporting force to protect the capacitor in the sample-and-hold circuit 111 or the analog-to-digital conversion circuit 112.

FIG. 2 is a side view diagram illustrating a source driver according to an embodiment of the disclosure. Referring to FIG. 2, the source driver 200 includes an integrated circuit chip 210, a sensitive circuit 220, a film 230 and bumps 240. In the present embodiment, the sensitive circuit 220 may include at least one of the sample-and-hold circuit 111 and the analog-to-digital conversion circuit 112 of the above embodiment of FIG. 1, but the disclosure is not limited thereto. The sensitive circuit 220 may include at least one capacitor, and the sensitive circuit 220 is disposed in the integrated circuit chip 210. In the present embodiment, the film 230 is disposed below the integrated circuit chip 210, and the integrated circuit chip 210 is mounted on the film 230 by the bumps 240. In the present embodiment, the bumps 240 may provide a fixed height and a supporting force to the sensitive circuit 220 in the integrated circuit chip 210.

For example, the bumps 240 may be attached to a metal layer of the integrated circuit chip 210 and another metal layer of the film 230. Thus, the integrated circuit chip 210 is fixed in the film 230 and in parallel to a plane formed by a first direction P1 and a second direction P2. In the present embodiment, the film 230 may be a flexible printed circuit (FPC) film, but the disclosure is not limited thereto. It should be noted that, one side of the integrated circuit chip 210 having the sensitive circuit 220 is disposed to face the film 230, and a gap is existed between the integrated circuit chip 210 and the film 230. Compared with the case where only some bumps are disposed on the boundary of the integrated circuit chip 210 and are disposed away from the sensitive circuit 220, in the present embodiment, the bumps 240 are disposed adjacent to the sensitive circuit 220, so the bumps 240 can effectively hold and protect at least portion of the integrated circuit chip 210 having the sensitive circuit 220 to avoid or reduce the structural deformation caused by a heating process. The structural deformation means, for example, that the portion of the integrated circuit chip 210 may bent toward a third direction P3 or other directions after the heating process. The first direction P1, the second direction P2 and the third direction P3 are perpendicular to each other. In addition, the bumps 240 may be gold balls or solder balls, etc., but the disclosure is not limited thereto.

FIG. 3 is a circuit diagram illustrating a sample-and-hold unit according to an embodiment of the disclosure. Referring to FIG. 3, in some embodiments of the disclosure, the above sample-and-hold circuit may include one or more sample-and-hold unit 311 as FIG. 3. The sample-and-hold unit 311 includes a switch Si and a capacitor C. The switch Si is coupled between the input terminal Vin and the output terminal Vout, and the capacitor C is coupled between the input terminal Vin and a reference voltage Vr. For example, the input terminal Vin is coupled to a pixel unit of a display panel, and the sample-and-hold unit 311 is configured to receive a voltage sample of the pixel unit when the switch Si is closed, so that the capacitor C will memorize the voltage sample when the switch Si is open. However, as illustrated in the above embodiments, the capacitor C of the sample-and-hold unit 311 is sensitive to structural deformation caused by the heating process, and thus the surrounding area of the sample-and-hold unit 311 may be provided with one or more bumps.

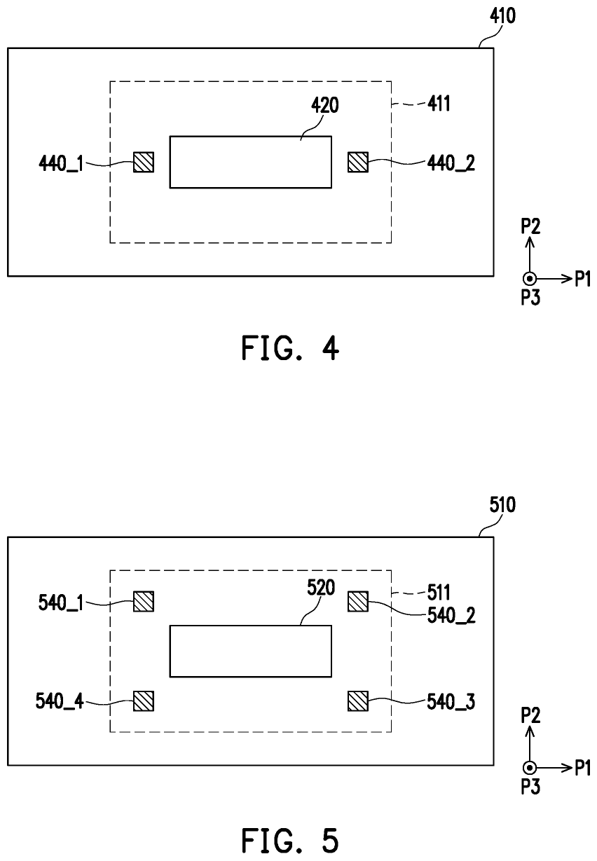

FIG. 4 is a top view diagram along the direction P3 illustrating an integrated circuit chip according to a first embodiment of the disclosure. Referring to FIG. 4, the integrated circuit chip 410 includes a sensitive circuit 420 and two bumps 440_1 and 440_2, and the sensitive circuit 420 and bumps 440_1 and 440_2 are disposed in a specific region 411 of the integrated circuit chip 410. The specific region may far from a boundary of the integrated circuit chip 410. Further, the integrated circuit chip 410 may further include other circuits, such as the driving circuit of the above embodiment, and the disclosure does not limit the arrangement positions of the other circuits in the integrated circuit chip 410.

In the present embodiment, the sensitive circuit 420 may include at least one of the above sample-and-hold circuit or the above analog-to-digital conversion circuit, so the sensitive circuit 420 may also include at least one capacitor. The sensitive circuit 420 may be an elongated shape, and the bumps 440_1 and 440_2 are adjacently located on two sides of the integrated circuit chip 410 along the direction P1, so that the bumps 440_1 and 440_2 can at least effectively prevent or reduce structural deformation of the specific region 411 of the integrated circuit chip 410 in the direction P1 caused by the heating process. However, the arrangement positions of the bumps 440_1 and 440_2 are not limited by FIG. 4. In another embodiment, the bumps 440_1 and 440_2 may be adjacently located on another two sides of the sensitive circuit 420 along the direction P2, or may be adjacently located on any two corners of the sensitive circuit 420. Further, the number of the bumps of the integrated circuit chip 410 also do not limited by FIG. 4. In yet another embodiment, in the specific region 411, the integrated circuit chip 410 may further include more bumps.

It should be noted that, in the present embodiment, the distance between the bump 440_1 and the sensitive circuit 420 is less than the distance between the bump 440_1 and the boundary of the integrated circuit chip 410, and the distance between the bump 440_2 and the sensitive circuit 420 is also less than the distance between the bump 440_2 and the boundary of the integrated circuit chip 410. Moreover, the bumps 440_1 and 440_2 are non-input-output bumps, or the bumps 440_1 and 440_2 do not coupled to any input-output pad. The bumps 440_1 and 440_2 may be coupled to a power pad, a ground pad or floating pad respectively, but the disclosure is not limited thereto. However, in some embodiments of the disclosure, the integrated circuit chip 410 may further include at least another bump, and the at least another bump is located on a region outside the specific region 411, where the at least another bump may be coupled to an input-output pad.

FIG. 5 is a top view diagram along the direction P3 illustrating an integrated circuit chip according to a second embodiment of the disclosure. Referring to FIG. 5, the integrated circuit chip 510 includes a sensitive circuit 520 and four bumps 540_1 to 540_4, and the sensitive circuit 520 and bumps 540_1 to 540_4 are disposed in a specific region 511 of the integrated circuit chip 510. Further, the integrated circuit chip 510 may further include other circuits, such as the driving circuit of the above embodiment, and the disclosure does not limit the arrangement positions of the other circuits in the integrated circuit chip 510.

Compared with the embodiment of FIG. 4, the bumps 540_1 to 540_4 are adjacently located on four corners of the integrated circuit chip 510, so that the bumps 540_1 to 540_4 can effectively prevent or reduce the influence of structural deformation of the specific region 511 of the integrated circuit chip 510 caused by the heating process. However, the number of the bumps and the arrangement positions of the bumps 540_1 to 540_4 are not limited by FIG. 5. In another embodiment, the integrated circuit chip 510 may further include more bumps.

In the present embodiment, the distance between each of the bumps 540_1 to 540_4 and the sensitive circuit 520 is less than the distances between each of the bumps 540_1 to 540_4 and a boundary of the integrated circuit chip 510, respectively. Moreover, the bumps 540_1 to 540_4 are non-input-output bumps, or the bumps 540_1 to 540_4 do not coupled to any input-output pad. The bumps 540_1 to 540_4 may be coupled to a power pad, a ground pad or floating pad respectively, but the disclosure is not limited thereto. However, in some embodiments of the disclosure, the integrated circuit chip 510 may further include at least another bump, and the at least another bump is located on a region outside the specific region 511, where the at least another bump may be coupled to an input-output pad.

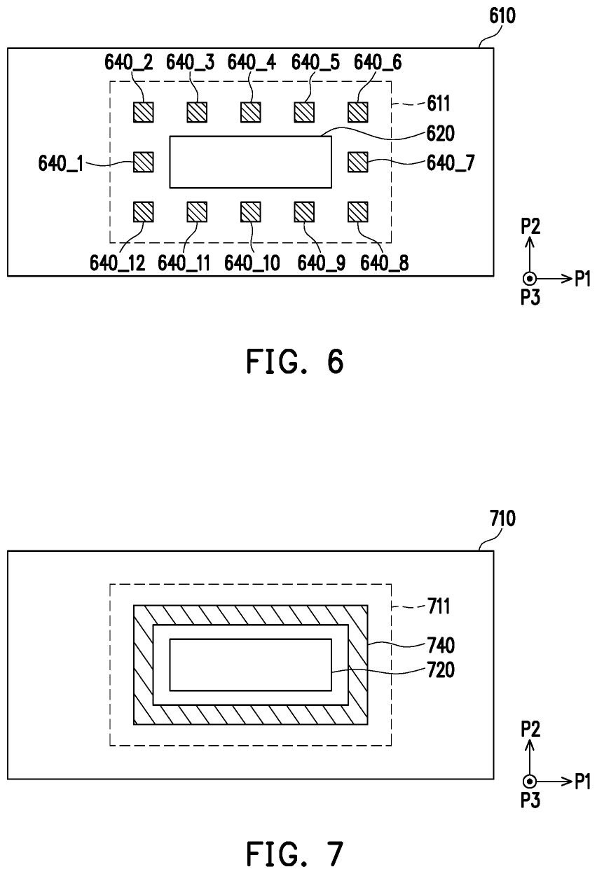

FIG. 6 is a top view diagram along the direction P3 illustrating an integrated circuit chip according to a third embodiment of the disclosure. Referring to FIG. 6, the integrated circuit chip 610 includes a sensitive circuit 620 and a plurality of bumps 640_1 to 640_12, and the sensitive circuit 620 and bumps 640_1 to 640_12 are disposed inside a specific region 611 of the integrated circuit chip 610. Further, the integrated circuit chip 610 may further include other circuits, such as the driving circuit of the above embodiment, and the disclosure does not limit the arrangement positions of the other circuits in the integrated circuit chip 610.

Compared with the embodiment of FIG. 4, the bumps 640_1 to 640_12 are adjacently located on surround of the integrated circuit chip 610, so that the bumps 640_1 to 640_12 can effectively prevent or reduce the influence of structural deformation of the specific region 611 of the integrated circuit chip 610 caused by the heating process. However, the number of the bumps and the arrangement positions of the bumps 640_1 to 640_12 are not limited by FIG. 6. In another embodiment, the integrated circuit chip 610 may further include more or less bumps.

In the present embodiment, the distance between each of the bumps 640_1 to 640_12 and the sensitive circuit 620 is less than the distance between each of the bumps 640_1 to 640_12 and a boundary of the integrated circuit chip 610, respectively. Moreover, the bumps 640_1 to 640_12 are non-input-output bumps, or the bumps 640_1 to 640_12 do not coupled to any input-output pad. The bumps 640_1 to 640_12 may be coupled to a power pad, a ground pad or floating pad respectively, but the disclosure is not limited thereto. However, in some embodiments of the disclosure, the integrated circuit chip 610 may further include at least another bump, and the at least another bump is located on a region outside the specific region 611, where the at least another bump may be coupled to an input-output pad.

FIG. 7 is a top view diagram along the direction P3 illustrating an integrated circuit chip according to a fourth embodiment of the disclosure. Referring to FIG. 7, the integrated circuit chip 710 includes a sensitive circuit 720 and a bump 740, and the sensitive circuit 720 and bumps 740 are disposed inside a specific region 711 of the integrated circuit chip 710. The bump 740 forms a closed shape to surround the sensitive circuit 720, but the disclosure is not limited thereto. In another embodiment, the bump 740 may form an open shape to surround the sensitive circuit 720. Further, the integrated circuit chip 710 may further include other circuits, such as the driving circuit of the above embodiment, and the disclosure does not limit the arrangement positions of the other circuits in the integrated circuit chip 710.

Compared with the embodiment of FIG. 4, the bump 740 are adjacently located on surround of the integrated circuit chip 710, so that the bump 740 can effectively prevent or reduce the influence of structural deformation of the specific region 711 of the integrated circuit chip 710 caused by the heating process. However, the number of the bump and the arrangement position of the bump 740 are not limited by FIG. 7. In another embodiment, the integrated circuit chip 710 may further include more bumps.

In the present embodiment, the distance between the bump 740 and the sensitive circuit 720 is less than the distance between the bump 740 and a boundary of the integrated circuit chip 710. Moreover, the bump 740 is non-input-output bumps, or the bump 740 does not coupled to any input-output pad. The bump 740 may be coupled to a power pad, a ground pad or floating pad respectively, but the disclosure is not limited thereto. However, in some embodiments of the disclosure, the integrated circuit chip 710 may further include at least another bump, and the at least another bump is located on a region outside the specific region 711, where the at least another bump may be coupled to an input-output pad.

In summary, the source driver of the disclosure can effectively prevent or reduce the influence of structural deformation of the integrated circuit chip caused by the heating process. The source driver of the disclosure can protect the sensitive circuit of the integrated circuit by arranging at least one bump adjacent to the surrounding of the sensitive circuit in the integrated circuit, thereby effectively preventing the integrated circuit chip from bending after the heating process. The sensitive circuit may include at least one of the sample-and-hold circuit and the analog-to-digital conversion circuit.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A source driver, comprising:
an integrated circuit chip;
a sample-and-hold circuit, disposed in the integrated circuit chip, and the sample-and-hold circuit comprises at least one capacitor; and
at least one bump, disposed in the integrated circuit chip, and the at least one bump is adjacent to the sample-and-hold circuit.

2. The source driver as claimed in claim 1, wherein a first distance between the at least one bump and the sample-and-hold circuit is less than a second distance between the at least one bump and a boundary of the integrated circuit chip.

3. The source driver as claimed in claim 1, wherein the at least one bump and the sample-and-hold circuit are disposed in a specific region of the integrated circuit chip, and the specific region is far from a boundary of the integrated circuit chip,
wherein the at least one bump is a non-input-output bump, and a region outside the specific region comprises at least another bump.

4. The source driver as claimed in claim 1, further comprising:
a film, disposed below the integrated circuit chip, and the film and the integrated circuit chip are mounted together by the at least one bump,
wherein a side of the integrated circuit chip having the sample-and-hold circuit is disposed to face the film, and a gap is existed between the integrated circuit chip and the film.

5. The source driver as claimed in claim 1, wherein the source driver further comprises a plurality of bumps, and the plurality of bumps are disposed in the integrated circuit chip and surround the sample-and-hold circuit.

6. The source driver as claimed in claim 5, wherein the plurality of bumps are adjacently located on at least two sides or at least two corners of the sample-and-hold circuit.

7. The source driver as claimed in claim 1, wherein the at least one bump forms a closed shape or an open shape to surround the sample-and-hold circuit.

8. A source driver, comprising:
an integrated circuit chip;
an analog-to-digital conversion circuit, disposed in the integrated circuit chip, and the analog-to-digital conversion circuit comprises at least one capacitor; and
at least one bump, disposed in the integrated circuit chip, and the at least one bump is adjacent to the analog-to-digital conversion circuit.

9. The source driver as claimed in claim 8, wherein a first distance between the at least one bump and the analog-to-digital conversion circuit is less than a second distance between the at least one bump and a boundary of the integrated circuit chip.

10. The source driver as claimed in claim 8, wherein the at least one bump and the analog-to-digital conversion circuit are disposed in a specific region of the integrated circuit chip, and the specific region is far from a boundary of the integrated circuit chip,
wherein the at least one bump is a non-input-output bump, and a region outside the specific region comprises at least another bump.

11. The source driver as claimed in claim 8, further comprising:
a film, disposed below the integrated circuit chip, and the film and the integrated circuit chip are mounted together by the at least one bump,
wherein a side of the integrated circuit chip having the analog-to-digital conversion circuit is disposed to face the film, and a gap is existed between the integrated circuit chip and the film.

12. The source driver as claimed in claim 8, wherein the source driver further comprises a plurality of bumps, and the plurality of bumps are disposed in the integrated circuit chip and surround the analog-to-digital conversion circuit.

13. The source driver as claimed in claim 12, wherein the plurality of bumps are adjacently located on at least two sides or at least two corners of the analog-to-digital conversion circuit.

14. The source driver as claimed in claim 8, wherein the at least one bump forms a closed shape or an open shape to surround the analog-to-digital conversion circuit.
